(19) United States
(12) Patent Application Publication
(10) Pub. No.: US 2008/0155101 A1
(43) Pub. Date: Jun. 26, 2008

(54) Reserving resources for data streams in a communication network

(75) Inventors: Burt Joseph Welsh, San Jose, CA (US); Sue Chang, Palo Alto, CA (US); Timothy Haitian Lau, San Lorenzo, CA (US); Bruce Thompson, Saratoga, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Cisco Technology, Inc., San Jose, CA (US)

(21) Appl. No.: 11/643,060

(22) Filed: Dec. 21, 2006

(51) Int. Cl. G06F 15/173

(52) U.S. Cl. 709/226

(57) ABSTRACT

In one embodiment, a reservation control node monitors messages transferred between a client and a server to determine if the client is establishing a session with the server to stream data on a data stream between the server and the client. If the reservation control node detects that such a session is being established, the control node reserves resources for the data stream. The reservation control node continues to monitor messages between the client and the server that relate to the session. If the monitored messages indicate the session is being torn down, the reservation control node automatically tears down the reservation between the client and the server to free the reserved resources for other use.

### TECHNICAL FIELD

The present disclosure relates generally to communication networks and in particular to reserving resources for data streams in a communication network.

### BACKGROUND

A communication network is a geographically distributed collection of nodes interconnected by communication links and segments for transporting communications (e.g., data, voice, video) between communication units (end nodes), such as personal computers, personal digital assistants (PDA's), set-top boxes and the like. Many types of communication networks are available, with the types ranging from local area networks (LANs) to wide area networks (WANs). LANs typically connect nodes over dedicated private communication links located in the same general geographical location, such as a building or campus. WANs, on the other hand, typically connect large numbers of geographically dispersed nodes over long distance communication links, such as common carrier telephone lines. The Internet is an example of a WAN that connects networks throughout the world, providing global communication between nodes on various networks. The nodes typically communicate over the network by exchanging discrete frames or packets of data according to pre-defined protocols, such as the transmission control protocol/Internet protocol (TCP/IP). In this context, a protocol is a set of rules defining how the nodes interact with each other.

In some communication networks, servers are configured to provide streams of data to users. These streams of data (data streams) are time synchronized data streams, such as audio data and video data, which are sent from the server to various destinations (e.g., a client). The data may include video data and/or audio data which are contained in one or more files stored at the server. This data is sometimes called a data asset or media object. A data asset or media object as used herein relates to a collection of data (e.g., a data file) that may be streamed on a data stream from a source to a destination. Examples of data assets or media objects include movies, animations, digitized audio and so on.

A protocol that may be used to establish and maintain a data stream between a client and a server is the Real Time Streaming Protocol (RTSP). RTSP is a standards-based control protocol designed for serving multimedia presentations to clients. RTSP is described in H. Schulzrinne, et al., “Real Time Streaming Protocol (RTSP)”, Request For Comments (RFC) 2326, which is available from the Internet Engineering Task Force (IETF).

RTSP uses sessions to communicate information between a client and a server. An RTSP session is considered a complete RTSP “transaction” between a client and a server. A session typically involves four phases: (1) establishing a data stream with the server to transport information from the server to the client, (2) starting the data stream, (3) controlling the data stream (e.g., forward, reverse, pause, stop the data stream) and (4) closing the data stream. For example, a session may involve setting up a data stream to stream a movie from the server to the client, the client notifying the server to start streaming the movie and the client terminating the data stream when the movie ends or the client no longer wishes the server to stream the movie to the client. In a RTSP session, TCP is used to transport messages (e.g., setup messages, play messages, etc.) between a client and server that are used to setup, teardown and control the operation of the data stream between the client and the server. The User Datagram Protocol (UDP) network transport protocol is often used to deliver the streamed data. Alternatively, TCP may be used to deliver the data.

RFC 2326 defines a number of methods that are used to establish and maintain RTSP sessions. These methods include the setup method, the play method, the describe method and the teardown method. The methods are specified in messages that are transferred between the client and the server.

The setup method may be used by a client to establish a session between the client and a server for purposes of streaming a specific data asset from the server to the client. The setup method is specified in an RTSP SETUP message which may also contain a Uniform Resource Identifier (URI), such as a Uniform Resource Locator (URL), that identifies the data asset that is to be streamed. The server typically processes the setup message by allocating resources at the server which are used to stream the data asset to the client.

The play method may be used by a client to cause a server to start streaming a data asset specified in a prior setup message to the client. The method is specified in an RTSP “play” message that is generated by the client and sent to the server to begin “playing” the data asset. The server typically processes the play message by retrieving the data asset and streaming the data asset to the client.

The describe method may be used by a client to retrieve a description of the data asset or presentation associated with the data asset from the server. The method is specified in an RTSP DESCRIBE (“describe”) message that is generated by the client and sent to the server to obtain the description. The server may process the describe message by generating a response containing the requested description and forwarding the response to the client. The description may include the bandwidth needed to stream the data asset.

The teardown method may be used by a client to stop the streaming of a data asset to the client and free the resources allocated at the server that are associated with streaming the data asset to the client. The method is specified in an RTSP “teardown” message that is generated by the client and forwarded to the server to tear down the session. The server may process the message by ending its streaming of the data asset to the client and freeing resources associated with streaming the data asset.

Another protocol that may be used to establish and maintain a data stream between a client and a server is the Internet Group Management Protocol (IGMP). IGMP is a standards-based control protocol designed for serving multimedia presentations to clients. IGMP is described in W. Fenner, et al., “Internet Group Management Protocol, Version 2”, Request For Comments (RFC) 2236, and in B. Cain, et al., “Internet Group Management Protocol, Version 3”, Request For Comments (RFC) 3376, which are available from the Internet Engineering Task Force (IETF).

IGMP does not use a session to communicate information between a client and a server. Instead there is one multicast data stream leaving the server for each movie that is shared between all the clients that want it. The User Datagram Protocol (UDP) network transport protocol is used to deliver the streamed data.

RFC 2236 and RFC 3376 define a number of methods that are used to join and leave multicast groups. These methods include the membership report method and the leave method. The methods are specified in messages that are transferred between the client and the network elements. The intermediate nodes are responsible for making copies of the data streams so that each client receives a copy of the data streams it has membership in.

The membership report method may be used by a client to cause the network elements to begin copying the stream of a specific media object from the server to the client. The method is specified in an IGMP “membership report” message which contains the multicast IP address of the group. The intermediate nodes typically process the membership report message by making a copy of the stream of the media object and sending it to the client.

The leave method may be used by a client to cause the intermediate nodes to stop copying a stream of the media object to the client. The method is specified in an IGMP “leave” message that is generated by the client and sent to the intermediate nodes to stop “playing” the media object. The intermediate nodes typically process the leave message by stopping copying the media object stream to the client.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 illustrates an example embodiment of a communication network.

FIG. 2 illustrates an example embodiment of a reservation control node.

FIG. 3 illustrates an example embodiment of an intermediate node.

FIG. 4 illustrates an example embodiment of a routing engine.

FIG. 5 illustrates an example Resource Reservation Protocol (RSVP) Path message.

FIG. 6 illustrates an example RSVP Reservation Request (Resv) message.

FIG. 7 illustrates various functional blocks associated with RSVP.

FIG. 8 illustrates an example dialog between a client and a server with respect to a data streaming session between the client and server using RTSP.

FIGS. 9A-E illustrate an example flow chart of a sequence of steps that may be used to stream data between a client and a server using RTSP.

FIG. 10 illustrates an example of a portion of the dialog between a client and a server shown in FIG. 8.

FIG. 11 illustrates an example dialog between a client and a server with respect to a data streaming session between the client and server using IGMP.

FIGS. 12A-C illustrate an example flow chart of a sequence of steps that may be used to stream data between a client and a server using IGMP.

### DESCRIPTION OF EXAMPLE EMBODIMENTS

### Overview

A method for reserving resources for data streams in a communication network includes monitoring one or more messages transferred between a first entity and a second entity in the communication network and determining from the monitored messages that a session to stream a data asset from the first entity to the second entity is being established. The method further includes reserving resources in the communication network that are to be used to accommodate streaming the data asset from the first entity to the second entity.

It is noted that illustrated embodiments are described herein as using the Resource Reservation Protocol (RSVP) to reserve resources in a communication network and the Real Time Streaming Protocol (RTSP) for the delivery of data in data streams. A version of RSVP that may be used with embodiments is described in R. Braden, et al., “Resource Reservation Protocol (RSVP)”, Request for Comments (RFC) 2205, September 1997, which is available from the Internet Engineering Task Force (IETF) and which is hereby incorporated by reference in its entirety as though fully set forth herein. A version of RTSP that may be used with embodiments is described in H. Schulzrinne, et al., “Real Time Streaming Protocol (RTSP)”, RFC 2326, April 1998, which is also available from the IETF and which is also hereby incorporated by reference in its entirety as though fully set forth herein. It is noted that other resource reservation protocols that reserve resources in a communication network as well as data streaming protocols that maintain the streaming of data in a communication network may be adapted for use with embodiments.

One problem with the above-described methods is that while resources are typically reserved at a server to support a data stream, resources in the communication network beyond the server are typically not reserved. This could pose problems for data streams that are carried in heavily used networks. For example, a heavily used network may become congested and may cause data carried by a data stream to be delayed. This, in turn, may introduce jitter which may cause audio and/or video information carried by the data stream to become garbled or incur noticeable gaps. Shortcomings associated with the above-described methods may be overcome by providing a technique for automatically reserving resources in a communication network for data streams carried by the communication network. The resources are reserved in a manner that is transparent to the protocol used to establish and maintain the dataflow.

According to an aspect of the technique, messages that are used to establish a data stream in the communication network are monitored. The monitored messages are examined to determine if a session to stream data between two entities in the communication network is being established. If so, resources are reserved to accommodate streaming the data asset between the entities.

In an embodiment of the technique, a client issues a Real Time Streaming Protocol (RTSP) SETUP message to establish a session to stream a data asset from a server to a client in a communication network on a data stream associated with the session. A reservation control node receives (monitors) the message, saves information about the data stream contained in the message and forwards the message to the server. The reservation control node issues an RTSP DESCRIBE message to obtain information (e.g., metadata) about the data asset from the server. (Note that bandwidth information may also be determined via the asset name.) The server processes the SETUP and DESCRIBE messages and issues a SETUP OK message to the client and a DESCRIBE OK message to the reservation control node, accordingly. The reservation control node receives the SETUP OK and DESCRIBE OK messages and uses the information contained therein as well as the previously saved information from the SETUP message to generate a Resource Reservation Protocol (RSVP) Path message to establish a reservation of resources for the data stream. The reservation control node then issues the Path message to reserve resources for the data stream.

After resources have been reserved, the reservation control node continues to monitor messaging activity between the client and server to determine if the session (and hence data stream) is being “torn down.” If so, the reservation control node generates and issues an RSVP PathTear message to tear down the reservation of resources and free the resources for other use.

Advantageously, by monitoring messaging activity associated with maintaining a data stream and automatically reserving resources for the data stream based on the messaging activity, embodiments may enable resources to be transparently served for the data stream. Reserving the resources for the data stream enables network resources to be dedicated to the data stream and acts to obviate negative effects (e.g., jitter) that may affect the performance of the data stream in the network that may be present if the network resources were not reserved.

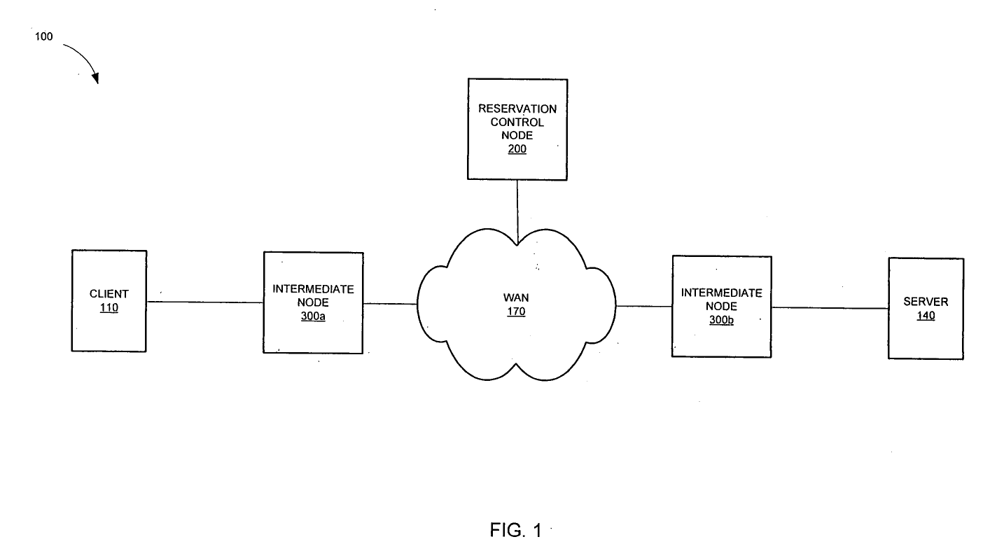

FIG. 1 is a high-level block diagram of an example embodiment of a communication network. Network 100 comprises a plurality of entities, such as client 110, intermediate nodes 300, reservation control node 200 and server 140, interconnected by links to form an internetwork of entities. The links may be some combination of wired links, optical links, wireless links and the like. The entities communicate by exchanging data packets according to a pre-defined set of network protocols, such as the Transmission Control Protocol/Internet Protocol (TCP/IP), RSVP, RTSP and IGMP. A network protocol as used herein is a formal set of rules that define how data is exchanged between entities in a communication network.

The client 110 is illustratively a conventional network node, such as a personal computer, personal digital assistant (PDA), set-top box, music/video player, mobile telephone and the like, that is capable of establishing data streams with the server 140. A data stream as used herein is a sequence of digitally encoded signals (e.g., data packets) that are streamed from a source (usually a server) to a destination (usually a client) at a specific rate usually measured in, e.g., Kilobits-per-second (Kbps) or Megabits-per-second (Mbps).

The server 140 is a conventional computer-based server configured to store data assets (e.g., movies, animations, videos, audio data) that are streamed to clients, such as client 110. The server 140 may be a video-on-demand (VoD) server configured to stream video data (e.g., movies) requested by the clients 110 to the clients 110.

The reservation control node 200 is a network node that is configured to establish and maintain reservations of resources in network 100 for data streams between a client and server 140. Illustratively, node 200 is configured as a “bump in the wire” in a path between the client 110 and the server 140 and behaves in a manner that is “transparent” to the traffic carried on the path. It is noted that in other embodiments, some or all of the functions performed by reservation control node 200, described below, are performed by an entity in network 100 other than the reservation control node, such as intermediate node 300. Moreover, the entity may not be directly placed in the path between the client 110 and the server 140. For example, RTSP packets destined for a client 110 or server 140 may be redirected by an intermediate node 300 to a node, such as a workstation, that is configured to process the packets in accordance with techniques described herein.

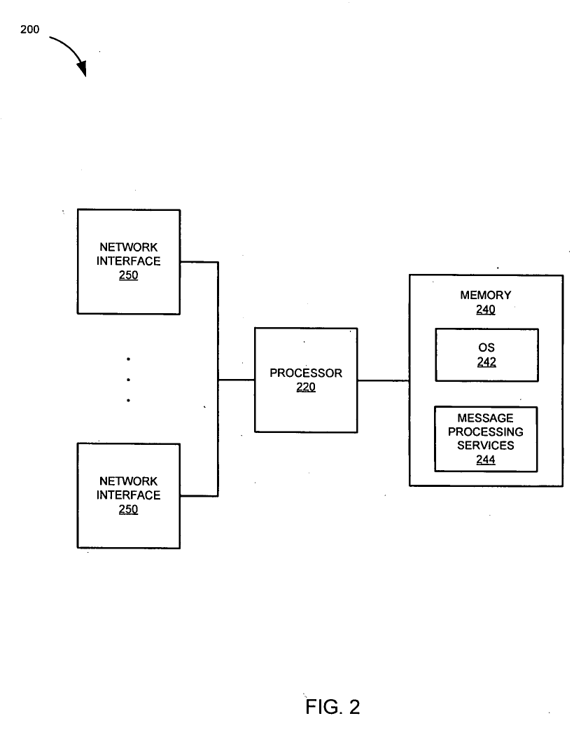

FIG. 2 is a block diagram of an example embodiment of a reservation control node 200. Node 200 comprises processing circuitry, one or more network interfaces 250 and a memory 240. An example of a reservation control node that may be used is the Cisco System Control Engine (SCE) 2000 available from Cisco Systems Incorporated, San Jose, Calif.

The network interfaces 250 are conventional network interfaces that connect (interface) the node 200 with the network 100 using various protocols, such as Ethernet. To that end, the network interfaces 250 comprise conventional interface circuitry that incorporates signal, electrical, and mechanical characteristics and interchange circuits needed to interface with the physical media of the network 100 and protocols running over that media.

The processing circuitry illustratively comprises processor 220 which is a conventional central processing unit (CPU) configured to execute instructions and manipulate data contained in the memory 240. The memory 240 is a conventional random access memory (RAM) comprising, e.g., dynamic RAM (DRAM) devices. Memory 240 contains an operating system (OS) 242 and message processing services 244. The OS 242 is a conventional operating system that comprises computer-executable instructions and data configured to support the execution of processes, such as message processing services 244, on processor 220. Specifically, operating system 240 is configured to perform various conventional operating system functions that, e.g., enable processes to be scheduled for execution on the processor 220 as well as provide controlled access to various resources of the reservation control node 200, such as memory 240 and the network interfaces 250. Message processing services 244 is a software process comprising computer-executable instructions and data configured, as will be described further below, to reserve resources for data streams carried in network 100.

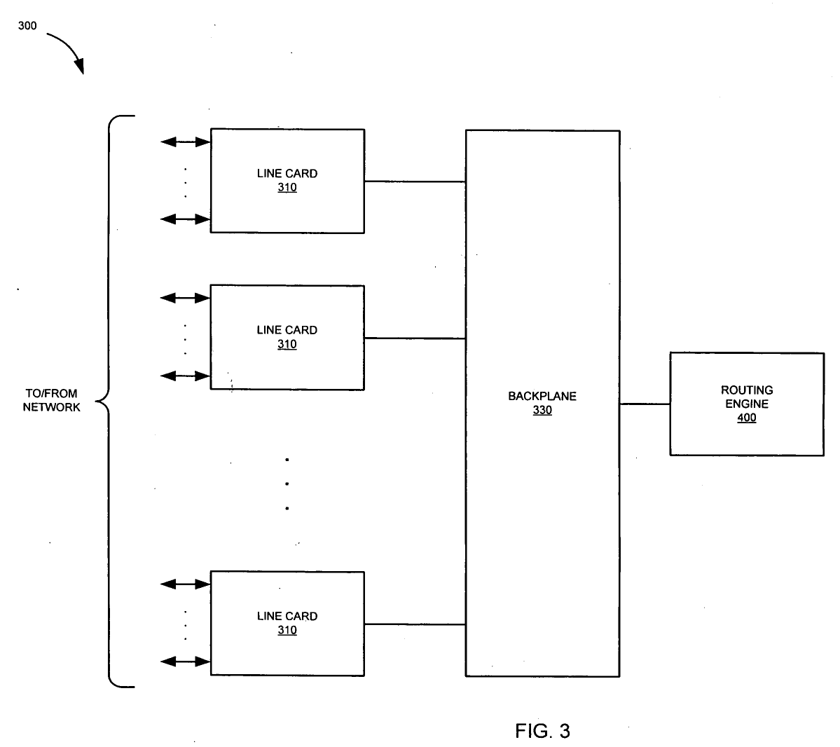

FIG. 3 is a high-level block diagram of an example embodiment of an intermediate node 300. Intermediate node 300 is illustratively a router comprising one or more line cards 310 and a routing engine card 400 interconnected by a backplane 330. Intermediate node 300 is configured to perform various conventional layer-2 (L2) and layer-3 (L3) switching and routing functions. As used herein, L2 and L3 refer to the data-link layer and the network layer, respectively, of the Open Systems Interconnection Reference Model (OSI/RM). Intermediate node 300 may also be configured to support various combinations of protocols including, e.g., Open Shortest Path First (OSPF), Intermediate-System-to-Intermediate-System (IS-IS), TCP/IP, RSVP, RTSP, Ethernet, Asynchronous Transfer Mode (ATM) and Frame Relay (FR). An example of an intermediate node that may be used is the Cisco 7600 Series Router available from Cisco Systems Incorporated.

The backplane 330 comprises point-to-point interconnections that interconnect the various cards and allow data and signals to be transferred between the cards. The line cards 310 connect (interface) the intermediate node 300 with the network and enable intermediate node 300 to transfer and acquire information (e.g., data packets) to and from the network via one or more ports using various protocols such as, e.g., ATM, Ethernet and FR. To that end, the line cards 310 comprise conventional interface circuitry that incorporates signal, electrical characteristics and interchange circuits, needed to interface with the physical media of the network 100 and the protocols running over that media. Functionally, the line cards 310 acquire information from the network 100 via ports and forward the information to the backplane as well as transfer information acquired from the backplane to the network via the ports. The ports may be conventional ports such as, e.g., ATM, Ethernet and FR ports.

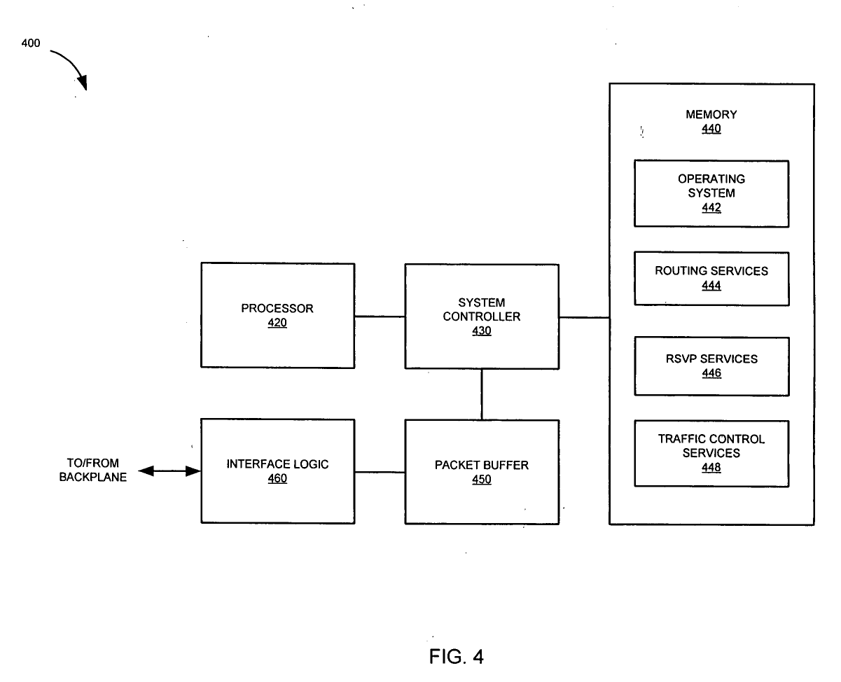

The routing engine 400 comprises logic that is configured to manage node 300, execute various protocols, such as RSVP and RTSP, and perform other functions including forwarding and routing various packets processed by node 300. FIG. 4 is a high-level block diagram of an example embodiment of a routing engine 400. Routing engine 400 comprises interface logic 460, packet buffer 450, system controller 430, processing circuitry and memory 440.

Interface logic 460 is coupled to the backplane 330 and is configured to transfer information (e.g., data) between the backplane 330 and the routing engine 400. Packet buffer 450 is a RAM comprising high-speed RAM devices (e.g., static RAM devices) capable of storing information acquired by the interface logic 460 and processed by the processor 420. System controller 430 is coupled to the processor 420, memory 440 and packet buffer 450 and comprises circuitry configured to enable the processor 420 to access (e.g., read, write) memory locations contained in the memory 440 and the packet buffer 450. The processing circuitry illustratively comprises processor 420 which is a conventional CPU configured to execute instructions and manipulate data contained in memory 440 for performing various functions associated with processing packets as described herein. The memory is a computer-readable medium comprising RAM devices, such as DRAM devices, and contains various software and data structures used by processor 420 including operating system 442, routing services 440, RSVP services 446, and traffic control services 448.

Operating system 442 comprises computer-executable instructions and data configured to implement a conventional operating system. The OS 442 is a conventional operating system that comprises computer-executable instructions and data configured to support the execution of processes, such as routing services 444, RSVP services 446 and traffic control services 448, on processor 420. Specifically, OS 442 is configured to perform various conventional operating system functions that, e.g., enable the processes to be scheduled for execution on the processor 420 as well as provide controlled access to various resources of the routing engine 400, such as memory 440.

Routing services 444 is a software process comprising computer-executable instructions and data configured to implement various routing protocols, such as OSPF, and IS-IS. These protocols are configured to manage a forwarding database (FDB) (not shown) containing, e.g., data used to make forwarding decisions for packets processed by the intermediate node 300. RSVP services 446 and traffic control services 448 are software processes configured to implement various aspects of the RSVP protocol and to reserve resources on the intermediate node 300 for, inter alia, data streams as described herein. RSVP services 446 and traffic control services 448 are described further below.

Operationally, packets are received at a line card 310 via a port and processed at the line card 310 to determine if the packets should be forwarded to other ports on the line card 310, to other line cards 310 or to the routing engine 400. Packets destined for other line cards 310 or the routing engine 400 are forwarded via the backplane 330 to the other line cards 310 or routing engine 400, accordingly. A packet forwarded to the routing engine 400 is received at interface logic 460 and placed in the packet buffer 450. Processor 420 processes the packet which may include identifying a destination for the packet. If the destination is another node in the network 100, the processor 420 then directs interface logic 460 to forward the packet via the backplane 330 to a line card 310 through which the other node may be reached.

It is noted that functions performed by the reservation control node 200 and intermediate nodes 300 may be implemented in whole or in part using some combination of hardware and/or software. It is further noted that computer-executable instructions and/or computer data may be stored in various computer-readable mediums, such as volatile memories, non-volatile memories, flash memories, removable discs, non-removable discs and so on. In addition, it is noted that various electromagnetic signals, such as wireless signals, electrical signals carried over a wire, optical signals carried over optical fiber and the like may be encoded to carry computer-executable instructions and/or computer data, e.g., in a communication network.

In accordance with RSVP, an RSVP Path message is used by a sender to indicate its presence to other nodes in a communication network as well as specify resources needed at those other nodes to accommodate a dataflow between the sender and a receiver. Nodes that receive and process the RSVP Path message note that resources are being reserved for the dataflow. As will be described further below, the resources are actually reserved for the dataflow when the nodes receive a corresponding RSVP reservation request (Resv) message.

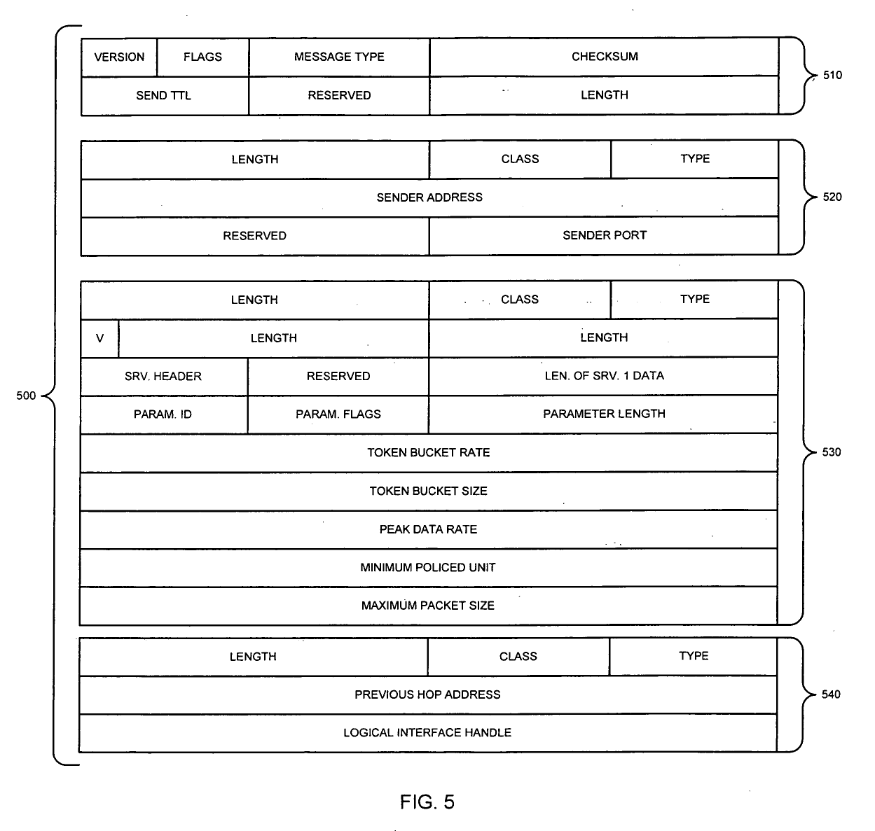

FIG. 5 is a block diagram of an example RSVP Path message 500. Message 500 comprises a common header 510, a sender template object 520, a traffic specification (Tspec) object 530 and a hop object 540. It is noted that message 500 may contain other objects, such as adspec objects. A message 500 generated by a particular node in the network 100 may contain a previous hop object 540 that contains an IP address of the reservation control. The IP address information contained in the previous hop object may be used by other nodes in the network 100 to route a corresponding RSVP reservation request (Resv) message to the node.

The header 510 contains a version field, a flags field, a message type field, a checksum field, a send “time-to-live” (TTL) field and a length field. The version field holds a value that identifies a version of the message 500. This version relates to a version of RSVP that may be used to interpret the message. The flags field holds flags associated with the message 500. The message type field holds an identifier (ID) that identifies the message 500 as an RSVP Path message. The checksum field holds a value that represents a checksum of the message 500. Illustratively, this value is a one's complement of the one's complement sum of the message. The send TTL field holds a value that represents a time-to-live value for the message 500 and the length field holds a value that represents a length of the message 500, illustratively in bytes.

The sender template object 520 holds information about the sender of the Path message 500. Specifically, object 520 comprises a length field, class field, type field, a sender address field and a sender port field. The length field holds a value that represents a length of the object 520, illustratively in bytes. The class field holds a value that identifies the object 520 as belonging to the RSVP_SENDER template class. The type field holds a value that indicates a type object within the object's class, such as an IP version 4 (IPv4) type object or an IP version 6 (IPv6) type object. This value may be used to interpret the type of address and port information contained in the sender address and sender port fields which hold values that represent an address (e.g., IPv4 address, IPv6 address) and a port (e.g., IPv4 port, IPv6 port), respectively, associated with the sender.

The Tspec object 530 holds information about traffic parameters associated with the dataflow and includes an object header and various traffic parameters. The object header holds information similar to the object header described above except that the class field holds a value that indicates the object 530 is in the RSVP_SENDER_Tspec class and the type field holds a value that indicates the type of object within this class. The traffic parameters may include parameters defined in various well-known “int-serv” working group documents, such as S. Shenker, et al., “General Characterization Parameters for Integrated Service Elements”, RFC 2215, which is available from the IETF and which is hereby incorporated by reference as though fully set forth herein.

In accordance with RSVP, a receiver responds to an RSVP Path message for a particular dataflow with an RSVP Resv message. The Resv message travels upstream hop-by-hop along the path used by the Path message from the receiver to the sender. Each node along the path receives the Resv message and reserves resources for the dataflow. The Resv message acts as a confirmation message that indicates to the sender that the requested resources have been reserved.

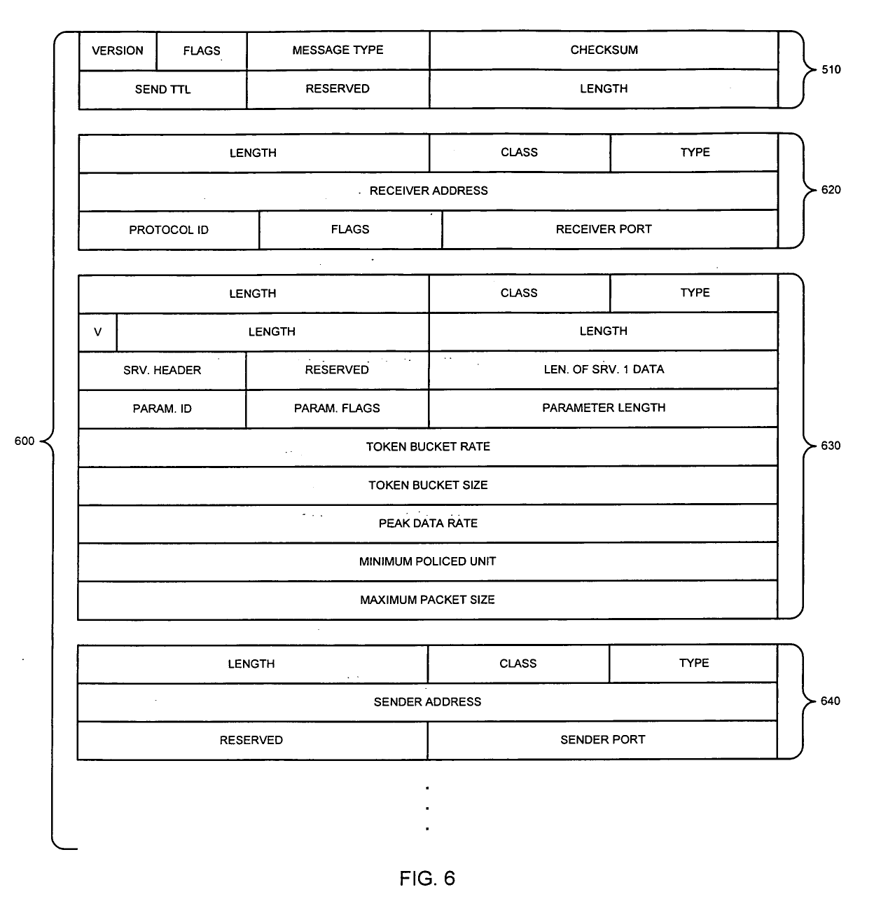

FIG. 6 illustrates an example RSVP Resv message 600. Message 600 comprises a common header 510, a session object 620, a flow specification (flow spec) object 630 and a filter specification (filter spec) object 640. It is noted that the Resv message may contain other objects, such as a reservation confirmation object.

The common header 510 contains information similar to the common header object described above except that the message type field contains a value that identifies the message as a Resv message. The session object 620 defines a session specification for the dataflow for which resources are being reserved. Specifically, the session object 620 contains an object header having length, class and type fields, a receiver address field, a protocol ID field, a flags field and a receiver port field. The object header contains information similar to the object headers described above except that the class field holds a value that identifies the session object as belonging to the RSVP SESSION class and the type field holds a value that indicates a type of the object (e.g., IPv4 session object, IPv6 session object) within the class. The receiver address and receiver port fields hold address (e.g., IP address) and port (e.g., IP port) information, respectively, that are associated with the receiver of the dataflow.

The flow spec object 630 contains information that defines various traffic characteristics associated with the new reservation. Specifically, the flow spec object 630 contains an object header, comprising length, class and type fields, and various traffic parameters. The object header contains information similar to the object headers described above except that the class field holds a value that indicates the object 630 belongs to the RSVP FLOW_SPEC class and the type field holds a value that indicates a type of object within the class. The traffic parameters may include parameters defined in various “int-serv” working group documents, such as parameters described in the previously incorporated RFC 2215.

The filter spec object 640 contains information related to the sender. Specifically, the filter spec object 640 contains an object header, a sender address field and a sender port field. The object header holds information similar to the object headers described above except that the class field holds a value that indicates the object belongs to the RSVP FILTER_SPEC class and the type field holds a value that indicates a type of address (e.g., IPv4, IPv6) and port contained in the sender address and sender port fields, respectively. The sender address and sender port fields hold an address and port, respectively, of the sender of the dataflow.

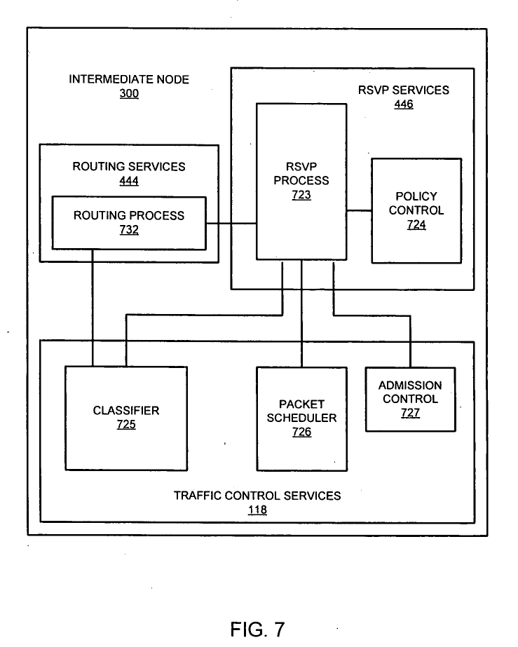

As noted above, intermediate node 300 contains various services including routing services 444, RSVP services 446 and traffic control services 448. The routing services 444 implement various conventional routing functions and the RSVP services 446 and traffic control services 448 implement various functions associated with RSVP. FIG. 7 illustrates the services in more detail.

The routing services 444 include a routing process 732 which performs various conventional routing functions, such as maintaining the FDB on intermediate node 300 and forwarding data packets at the L3 layer. These data packets may include data packets associated with RSVP, such as packets containing RSVP Path and Resv messages. The routing process 732 may be configured to implement various conventional routing protocols, such as OSPF and IS-IS.

The RSVP services 446 comprise a policy control function 724 and an RSVP process 723. The policy control function 724 determines whether a particular requestor associated with a reservation request message has appropriate privileges to reserve resources on the intermediate node 300. The RSVP process 723 is configured to manage reservations and process messages (e.g., Path messages, Resv messages) associated with reservations. This processing may include maintaining various state (e.g., session tables) associated with reservations processed by the intermediate node 300.

The traffic control services 448 comprise an admission control function 727, a packet scheduler 726 and a classifier 725. The admission control function 727 determines if the intermediate node 300 has sufficient resources to accommodate a particular request for resources specified in a reservation request message. The packet scheduler 726 and classifier 725 are configured to handle data packets associated with data flows which already have resources reserved on the intermediate node 300 and achieve a level of quality of service (QoS) for those data flows. Specifically, the packet classifier 725 determines QoS classes for data packets and the packet scheduler 726, and schedules the data packets for transfer from the intermediate node 300 onto the network 100 according to each data packet's QoS class.

In accordance with RSVP, a flow spec object 630 in combination with a filter spec object 640 is often called a flow descriptor. The flow spec 630 specifies a desired QoS and the filter spec 640 together with the session information defines a set of packets to receive the QoS specified in the flow spec. The flow spec 630 is used to establish parameters in a packet scheduler 726 or other data link layer mechanisms while the filter spec 640 is used to set parameters in the packet classifier 725. Data packets that are addressed to a particular RSVP session but do not match any of the filter specs 640 for that RSVP session are handled as best effort traffic.

Operationally, a Path message that is generated and issued by a sender is acquired by an intermediate node 300 in the path between the sender and a receiver. The message is forwarded to the intermediate node's RSVP process 723 by its routing services 444. The RSVP process 723 processes the Path message including directing the policy control 724 to determine if the sender that issued the Path message has permission to make a reservation on the intermediate node 300. If the sender that issued the Path message does not have permission to reserve resources on the intermediate node 300, an error message is generated and forwarded to the sender, and the request is ignored; otherwise the intermediate node 300 maintains information about the Path message at node 300 and forwards the Path message to the next node in the path.

Likewise, a Resv message that is generated and issued by a receiver, in response to the Path message, is acquired by an intermediate node 300 and is forwarded by the routing services 444 to the RSVP process 723. The RSVP process 723 processes the Resv message including directing the policy control 724 to determine if the receiver that issued the Resv message has permission to reserve resources (make a reservation) on the intermediate node 300. If the receiver that issued the Resv message does not have permission to reserve resources on the intermediate node 300, an error message is generated and forwarded to the receiver, and the request to reserve resources specified by the Resv message is ignored.

Otherwise, the RSVP process 723 queries the admission control 727 to determine if sufficient resources are available on the intermediate node 300 for the reservation associated with the Resv message. If sufficient resources are available, various parameters are established in the packet classifier 725 and packet scheduler 726 to obtain a QoS requested by the Resv message. If sufficient resources are not available, a check is performed to determine if one or more lower-priority reservations may be pre-empted to provide the resources. If so, some or all of the lower-priority reservations are pre-empted and the resources allocated to the pre-empted reservations are re-allocated to the reservation associated with the Resv message. Otherwise, if resources are not available for the reservation associated with the Resv message, an error message is generated and forwarded to the receiver that issued the Resv message.

Messages between nodes (e.g., a client and a server) in a communication network may be monitored to determine if a data stream is being established between the nodes. If so, resources are reserved for the data stream. For example, in network 100, messages transferred between client 110 and server 140 are monitored by reservation control node 200 to determine if a session is being established to stream a data asset (e.g., a media object) from the server 140 to the client 110. If so, reservation control node 200 reserves resources for the session to accommodate the data stream.

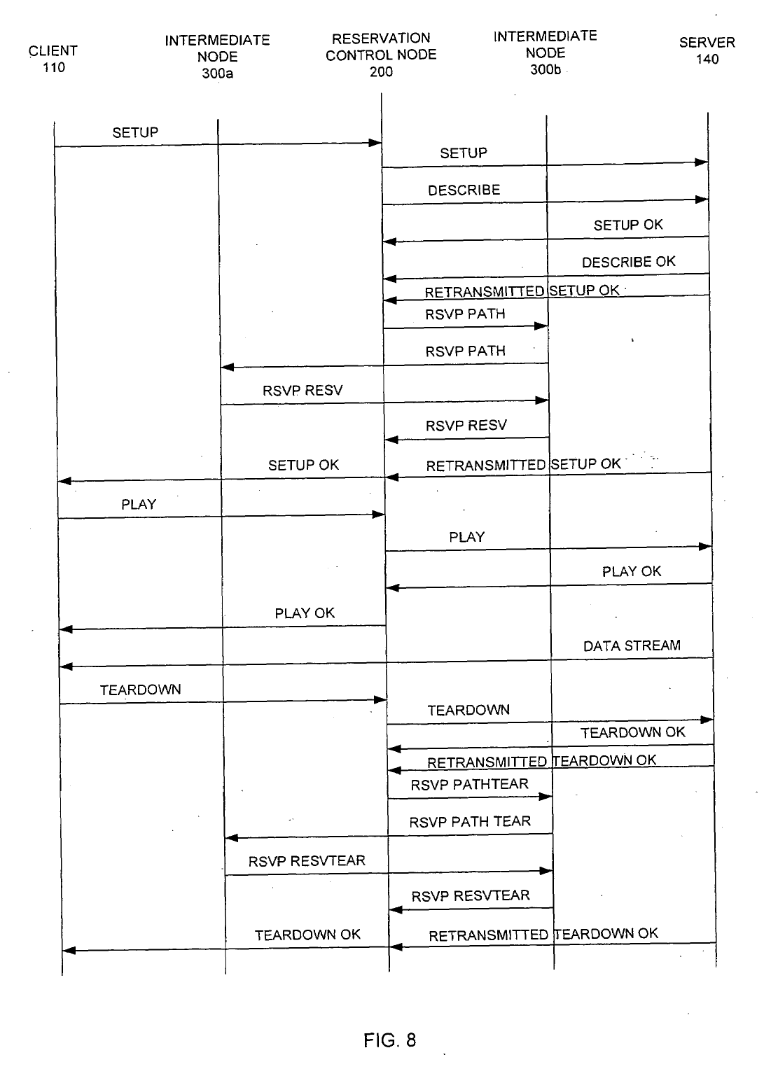

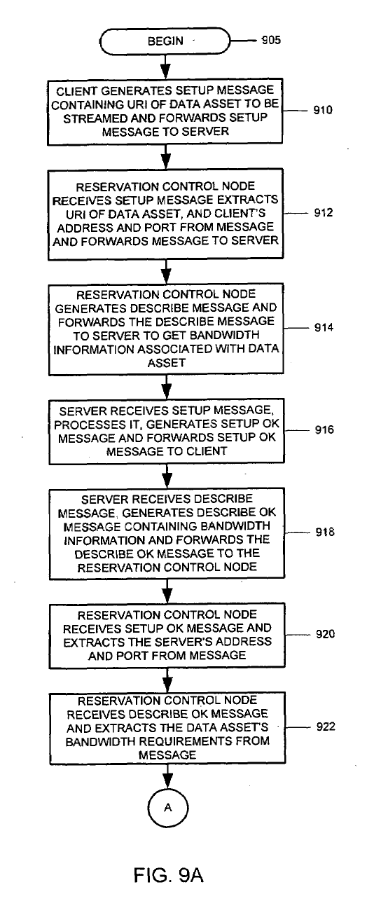

FIG. 8 is an illustration of a dialog between the client 110 and the server 140 that may be used to (1) monitor messages between the client 110 and the server 140, (2) determine a data streaming session is being established between the client 110 and server 140, (3) reserve resources for a data stream associated with the session, (3) tear down the session and (4) return the reserved resources. Referring to FIG. 8, a client 110 initiates a session with the server 140 by (1) generating an RTSP SETUP message that specifies a data asset to be streamed on a data stream associated with the session and (2) forwarding the SETUP message to the server 140. The SETUP message travels from the client 110 to intermediate node 300a which forwards the SETUP message to the server 140 via the WAN 170.

The reservation control node 200 receives the SETUP message, examines the SETUP message, determines that a session is being established between the client 110 and the server 140, saves certain information from the SETUP message and forwards the SETUP message to the server 140 via intermediate node 300b. The reservation control node 200 then obtains information about the data asset (e.g., bandwidth requirements needed to stream the data asset) from the server 140 by generating an RTSP DESCRIBE message to request the information about the data asset and forwarding the DESCRIBE message to the server 140.

The server 140 receives the SETUP message and, in response, generates and forwards an RTSP SETUP OK reply message to the client. In addition, the server 140 receives the DESCRIBE message and, in response, generates and forwards a DESCRIBE OK reply message containing the requested information to the reservation control node 200. Note that bandwidth information may also be determined via the asset name specified in the SETUP message.

The reservation control node 200 receives the SETUP OK and DESCRIBE OK reply messages, generates an RSVP Path message 500 from information contained in the SETUP, SETUP OK and DESCRIBE OK messages to reserve resources for the data stream and forwards the Path message 500 to intermediate node 300b via a tunnel that is established between the reservation control node 200 and intermediate node 300b. Illustratively, the Path message 500 is encapsulated in a Generic Routing Encapsulation (GRE) tunnel packet which is forwarded on the tunnel to intermediate node 300b. A version of GRE that may be used is described in S. Hanks, et al., “Generic Routing Encapsulation (GRE)”, RFC 1701, October 1994, S. Hanks, et al., “Generic Encapsulation Over IPv4 Networks“, October 1994, and D. Farinacci, et aL, “Generic Routing Encapsulation (GRE)”, RFC 2784, March 2000, all of which are available from the IETF and all of which are hereby incorporated by reference in their entirety as though fully set forth herein.

The reservation control node 200 acts as an RSVP proxy for server 140. The reservation control node appears to be directly connected to intermediate node 300b by the GRE tunnel. The reservation control node 200 will use the senders IP address in the Sender Template object, but the reservation control node 200 will put its own address in the Hop object. Intermediate node 300b receives the tunnel packet, extracts the Path message 500 from the tunnel packet and forwards the Path message 500 towards the client 110. Intermediate node 300a receives the Path message 500 and, acting as an RSVP proxy for the client, processes the Path message 500 including generating an RSVP Resv message 600 in response to the Path message 500 and forwarding the Resv message 600 to the server 140. Intermediate node 300b receives the Resv message 600 and concludes that resources have been reserved between intermediate node 300a and intermediate node 300b for the data stream. Intermediate node 300b then encapsulates the Resv message 600 in a tunnel packet, as described above, and forwards the tunnel packet to the reservation control node 200 via the tunnel to the IP address that was specified in the original RSVP Path hop object 540. Note that original RSVP Path hop object IP address could be set to the reservation nodes 200 regular IP address. This simplifies the process because the GRE tunnel is only needed for the original RSVP Path message. The corresponding RSVP Resv message can be sent normally by the first hop intermediate node 300b.

Reservation control node 200 receives the tunnel packet, removes the Resv message 600 contained therein and processes it including concluding that resources have been successfully reserved for the data stream. At this point, the reservation control node forwards the previously received SETUP OK message to the client 110. The client 110 eventually receives the SETUP OK message and concludes that the data stream for playing the data asset has been setup between the client 110 and the server 140. The client 110 then requests to have the server begin playing the data asset by issuing an RTSP PLAY message. The reservation control node 200 receives the PLAY message and processes it including noting that the client 110 has requested to begin playing the data asset. The reservation control node 200 then forwards the PLAY message to the server 140. The server 140 receives the PLAY message and responds by playing the media object (i.e., streaming the object to the client) and, generating and forwarding an RTSP PLAY OK message to the client 110. The reservation control node 200 intercepts the PLAY OK message and forwards it to the client 110. The client 110 receives the PLAY OK message and concludes that the server 140 has acknowledged its request to play the data asset. The server 140 plays the data asset on the data stream to the client 110.

Eventually, the client 110 chooses to “tear down” the session (and hence data stream) and, generates an RTSP TEARDOWN message and forwards the TEARDOWN message to the server 140 to tear down the session. The reservation control node 200 receives the TEARDOWN message, notes that the client is tearing down the session and forwards the TEARDOWN message to the server 140. The server 140 receives the TEARDOWN message, generates a TEARDOWN OK message and forwards the TEARDOWN OK message to the client 110. The reservation control node 200 receives the TEARDOWN OK message and holds on to it until the reservation associated with the session is torn down.

The reservation control node 200 initiates the teardown of the reservation by generating an RSVP PathTear message, encapsulating the message in a tunnel packet and forwarding the tunnel packet to node 300b. Node 300b receives the tunnel packet and removes the PathTear message from the tunnel packet and forwards the PathTear message to the client 110. The client's RSVP proxy node 300a receives the PathTear message and processes it including generating and forwarding an RSVP ResvTear message to the server 140.

The server's RSVP proxy node 300b receives the ResvTear message and concludes that the resources reserved for the data stream have been released. Node 300b then encapsulates the ResvTear message in a tunnel packet and forwards the tunnel packet to the reservation control node 200 on the tunnel to the IP address that was specified in the original RSVP PathTear hop object. Note that the original RSVP PathTear Hop object EP address could be set to the reservation nodes 200 regular IP address. This simplifies the process because the GRE tunnel is only needed for the original RSVP PathTear message. In this case the corresponding RSVP ResvTear message is sent normally by the first hop intermediate node 300b to the reservation control node 200. The reservation control node 200 receives the tunnel packet, removes the ResvTear message and, concludes (1) that the reservation of resources for the data stream has been torn down and (2) that the reserved resources have been returned to the network 100. The reservation control node 200 then forwards the TEARDOWN OK message to the client 110 which receives the TEARDOWN OK message and concludes that the data stream has been successfully torn down.

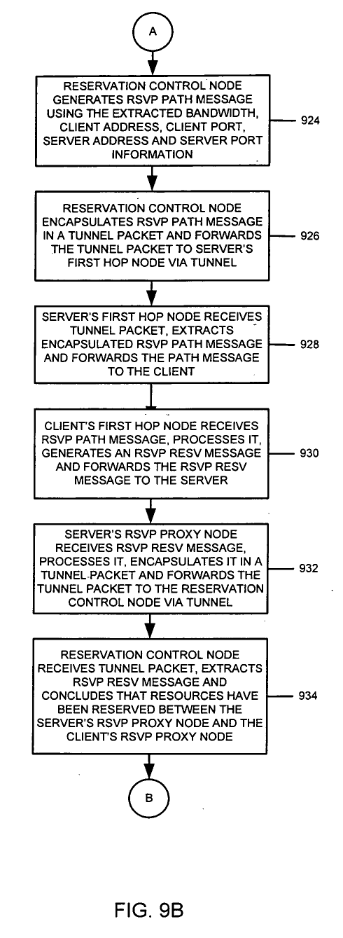

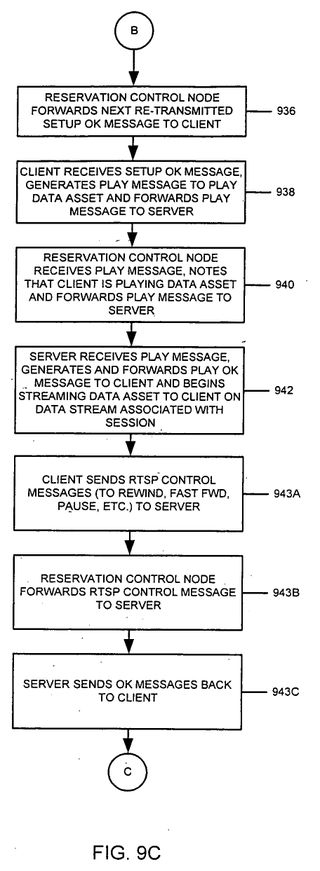

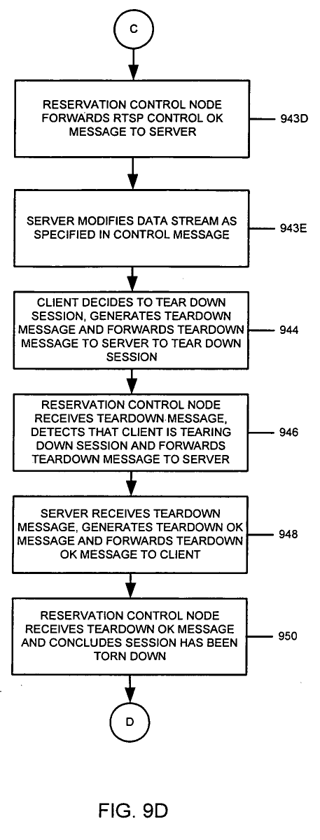

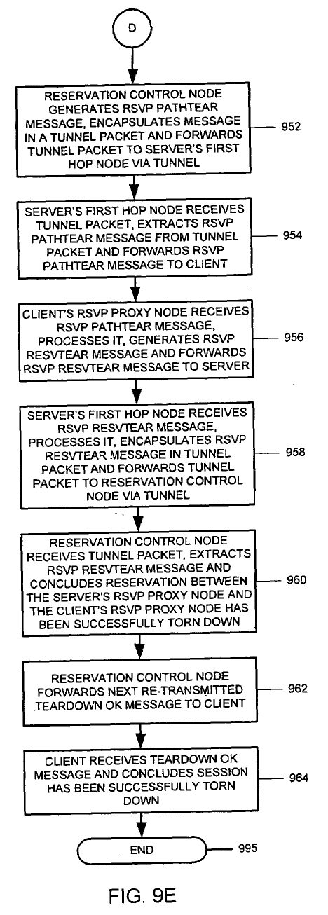

FIGS. 9A-E illustrate a flowchart of a sequence of steps that may be used to establish a session for streaming a data asset on a data stream from a server 140 to a client 110 using RTSP. The sequence begins at step 905 and proceeds to step 910 where the client 110 generates an RTSP SETUP message that specifies, inter alia, the client's address and port information and a Uniform Resource Indicator (URI), such as a Uniform Resource Locator (URL), of the data asset and forwards the message to the server 140. Next, at step 912, the reservation control node 200 receives the SETUP message, extracts the URI of the data asset, and the client's address and port information from the SETUP message and forwards the SETUP message to the server 140. At step 914, node 200 generates a request to obtain more information about the data asset and forwards the request to the server 140. Specifically, node 200 illustratively generates an RTSP DESCRIBE message containing the extracted URI and forwards the DESCRIBE message to the server 140 to acquire information about the data asset including bandwidth information associated with the data asset.

The server 140 receives the SETUP message at step 916, and processes it including generating a SETUP OK reply message, containing, inter alia, the server's address and port information, and forwards the reply message to the client 110. At step 918, the server 140 receives the DESCRIBE message, generates a DESCRIBE OK reply message containing the bandwidth information associated with the data asset and forwards the reply message to node 200. Next, at step 920, node 200 receives the SETUP OK message and extracts the server's address and port from the message. Although the SETUP OK is addressed to the client 140, node 200 does not forward the packet until after the RSVP reservation is complete. At step 922, node 200 receives the DESCRIBE OK message and extracts the bandwidth information from the message.

At step 924, node 200 generates, an RSVP Path 500 message using the extracted bandwidth, client address, client port, server address and server port information. At step 926, node 200 encapsulates the Path message 500 in a tunnel packet and forwards the tunnel packet to the server's First Hop intermediate node 300b via a tunnel between node 200 and the server's First Hop node 300b. Next, at step 928, the server's First Hop node 300b receives the tunnel packet, extracts the Path message 500 and forwards the Path message 500 to the client 110. Note the reservation control node 200 is the RSVP Sender Proxy for the server 140, the Last Hop intermediate node 300a is the RSVP Receiver Proxy for the client 110). The client's RSVP proxy 300a, at step 930, receives the Path message 500, processes it, generates an RSVP Resv message 600 and forwards the Resv message 600 to the server 140. The server's First Hop intermediate node 300b eventually receives the Resv message 600, at step 932, processes it including encapsulating the Resv message 600 in a tunnel packet and forwarding the tunnel packet to node 200. At step 934, node 200 receives the tunnel packet, extracts the Resv message 600 contained therein and concludes that resources had been reserved between the server's RSVP proxy node 300b and the client's RSVP proxy node 300a.

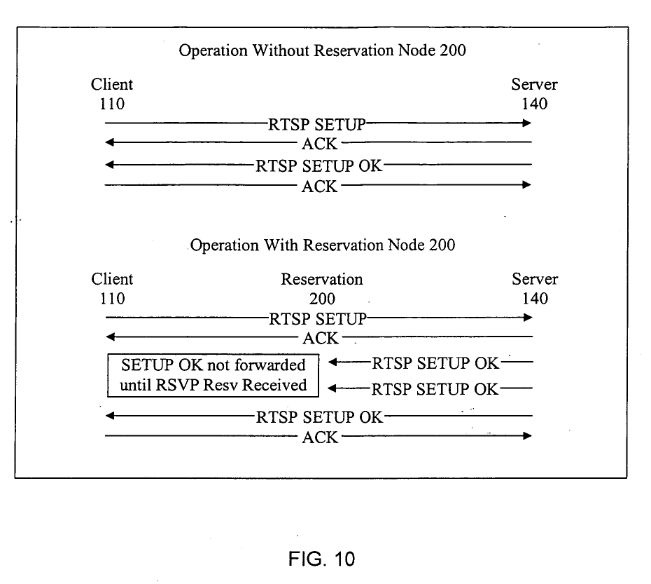

At step 936, node 200 forwards the next received SETUP OK message to the client 110. Note that, in the interval between the first RTSP Setup OK from the server 140 and the RSVP Resv from the First Hop intermediate node 300b, the server 140 has been retransmitting the RTSP SETUP OK according to the normal operation of TCP/IP. After the reservation control node 200 receives the RSVP Resv message the reservation control node 200 forwards the next RTSP SETUP OK packet from the server 140 to the client 110). This can be further understood with reference to FIG. 10 which shows the effect of operation with and without the reservation control node 200. At step 938, the client 110 receives the SETUP OK message, generates an RTSP PLAY message to play the data asset and forwards the PLAY message to the server 140. The PLAY message travels via the network to node 200 where, at step 940, node 200 receives the PLAY message, notes that the client 110 is playing the data asset and forwards the PLAY message to the server 140. At step 942, the server 140 receives the PLAY message and responds by sending a PLAY OK message back to the client 110. This Play OK message is also intercepted and forwarded to the client 110 by the reservation control node 200. After the client 110 receives the PLAY OK (and replies with a TCP ACK) the server 140 begins streaming the data asset to the client 110.

At step 943A, the client sends RTSP control messages (to rewind, fast forward, pause, etc.) to the server. The reservation control node forwards RTSP control messages to the server at step 943B. The server sends OK messages back to the client at step 943C. At step 943D, the reservation control node forwards RTSP control OK message to the server. At step 943E, the server modifies the data stream as specified in the control messages.

Eventually, the client 110 decides to tear down the session, generates an RTSP TEARDOWN message to tear down the session between the client 110 and the server 140 and forwards the TEARDOWN message to the server 140, at step 944. At step 946, reservation control node 200 receives the TEARDOWN message and forwards the TEARDOWN message to the sever 140. At step 948, the server receives the TEARDOWN message, processes it in a conventional manner, generates a TEARDOWN OK message and forwards the TEARDOWN OK message to the client 110. At step 950, node 200 receives the TEARDOWN OK message and concludes the session has been torn down. At step 952 (FIG. 9D), reservation control node 200 generates and forwards a reservation tear down message to tear down the reservation of resources and make the resources available to other reservations. Illustratively, the tear down message is an RSVP PathTear message which is encapsulated in a tunnel packet and forwards the tunnel packet to the server's first hop node 300b via the tunnel

At step 954, the server's first hop node 300b receives the tunnel packet, extracts the PathTear message contained therein and forwards the PathTear message to the client 110. The client's RSVP proxy 300a, at step 956, receives the PathTear message, processes it in a conventional manner, generates an RSVP ResvTear message and forwards the ResvTear message to the server 140. Next, at step 958, the server's first hop node 300b receives the ResvTear message and, processes it in a conventional manner, encapsulates the ResvTear message in a tunnel packet and forwards the tunnel packet to node 200. At step 960, node 200 receives the tunnel packet, extracts the ResvTear message from the packet and processes it including concluding that the reservation between the server's RSVP proxy node 300b and the client's RSVP proxy node 300a has been successfully torn down.

At step 962, reservation control node 200 forwards the TEARDOWN OK message to the client 110. At step 964, the client 110 receives the TEARDOWN OK message and concludes that the session has been successfully torn down. The sequence ends at step 995.

For example, referring to FIGS. 1 and 9A-E, assume client 110 wishes to stream a multimedia object (e.g., a video) stored on server 140 to the client 110. The client 110 initiates a session between the client 110 and server 140 to carry the multimedia object by generating an RTSP SETUP message containing a URI of the multimedia object and forwards the generated SETUP message to the server 140 (step 910), as described above, to establish an RTSP session between the client 110 and the server 150. The message travels through the network 100 via intermediate node 300a and WAN 170, and eventually reaches reservation control node 200.

Node 200 receives the SETUP message and extracts the multimedia object's URI, the client address and port from the setup message, and forwards the message to the server 140 (step 912). Specifically, a network interface 250 receives the SETUP message and forwards the message to the processor 220. The processor 220 processes the SETUP message including extracting the URI of the multimedia object from the SETUP message as well as the address and port of the client 110, and saving the extracted information in memory 240. The processor 220 then forwards the SETUP message to the server 140 via a network interface 250.

Node 200 then generates an RTSP DESCRIBE message and forwards the DESCRIBE message to the server 140 to obtain bandwidth information associated with the multimedia object (step 914). Specifically, the processor 220 generates a DESCRIBE message that contains information associated with the data stream in a conventional manner and forwards the DESCRIBE message via a network interface 250 to server 140.

The server 140 receives the SETUP message and processes it including generating an RTSP SETUP OK message and forwarding the SETUP OK message to the client 110 (step 916). The server 140 then receives the DESCRIBE message and processes it including generating an RTSP DESCRIBE OK message containing the bandwidth information associated with the multimedia object and forwards the DESCRIBE OK message to the reservation control node 200 (step 918).

The SETUP OK message forwarded by the server 140 travels via the network 100 to node 200 where it is received by the reservation control node 200 which extracts the server's address and port information from the SETUP OK message (step 920). Specifically, a network interface 250 receives the SETUP OK message and forwards the message to the processor 220. The processor 220 extracts the server's address and port information from the SETUP OK message and saves the information in memory 240.

The reservation control node 200 then receives the DESCRIBE OK message and extracts the bandwidth information associated with the multimedia object from the message (step 922). Specifically, a network interface 250 receives the DESCRIBE OK message and forwards the message to the processor 220. The processor 220 extracts the bandwidth information from the DESCRIBE OK message and saves the information in memory 240.

The reservation control node 200 then uses the extracted URI, bandwidth, client address, client port, server address and server port information to generate an RSVP Path message 500 in a conventional manner (step 924). The reservation control node 200 then encapsulates the generated Path message 500 in a tunnel packet and forwards the tunnel packet to the server's RSVP proxy node 300b via a previously established tunnel between the reservation control node 200 and the server's RSVP proxy node 300b (step 926). Specifically, the processor 220 encapsulates the Path message 500 in a GRE tunnel packet in a conventional manner and forwards the tunnel packet to the server's first hop node 300b via the tunnel.

The server's first hop node 300b receives the tunnel packet, extracts the Path message 500 contained therein and forwards the Path message 500 to the client 110 (step 928). Specifically, node 300b receives the tunnel packet at a line card 310 which forwards the packet via the backplane 330 to routing engine 400. The routing engine 400 receives the packet via the backplane at interface logic 460 which places the packet in the packet buffer 450 and notifies the processor 420 that a packet has been received. The processor 420 accesses the packet in the packet buffer 450 via the system controller 430 and processes it including removing the Path message 500 contained therein from the tunnel packet, performing conventional RSVP processing of the Path message 500 and forwarding the Path message to the client 110 via an appropriate line card 310.

The packet travels hop-by-hop from node 300b via WAN 170 where it is eventually received at the client's RSVP proxy node 300a. The client's RSVP proxy node 300a processes the Path message 500 in a conventional manner including generating an RSVP Resv message 600 and forwarding the Resv message 600 to the server 140 (step 930). Specifically, a line card 310 at node 300a receives the Path message 500 and forwards it via the backplane to routing engine 400. The routing engine 400 receives the message 500 at interface logic 460 which places the message 500 in packet buffer 450. The processor 420 via system controller 430 accesses the message 500 in packet buffer 450, determines that the message 500 is an RSVP Path message and processes it in a conventional manner including generating an RSVP Resv message 600 and forwarding the Resv message 600 via a line card 310 to the server 140.

The Resv message 600 travels hop-by-hop from the client's RSVP proxy node 300a through the WAN 170 to the server's first hop node 300b along the path used by the Path message 500. Node 300b receives the message 600, processes it in a conventional manner, encapsulates the message in a tunnel packet and forwards the tunnel packet to the reservation control node 200 via the tunnel (step 932).

The reservation control node 200 receives the tunnel packet, extracts the Resv message 600 and processes it including concluding that resources have been successfully reserved between the server's RSVP proxy node 300b and the client's RSVP proxy node 300a (step 934). Specifically, a network interface 250 receives the tunnel packet from the tunnel and forwards the packet to processor 220. The processor 220 examines the packet, determines that it is a Resv message 600 that is associated with the Path message 500 and concludes that the reservation of resources between node 300a and 300b has been successful.

The reservation control node 200 then forwards the next transmitted SETUP OK message to the client 110 (step 936). The SETUP OK message travels via the network 100 to the client 110 where it is eventually received by the client 110. The client 110 processes the SETUP OK message and concludes that a session between the client 110 and the server 140 for streaming the requested media object has been successfully established. The client 110 then generates and forwards an RTSP PLAY message to the server to cause the server 140 to begin streaming the media object to the client 110 (step 938).

The PLAY message travels via the network 100 and is received by the reservation control node 200. The reservation control node 200 notes that the client 110 has requested to play the media object and forwards the PLAY message to the server 140 (step 940). The PLAY message travels via the network to server 140. The server 140 receives the PLAY message, generates and forwards a PLAY OK message to the client 110, and begins streaming the media object to the client 110 (step 942). All other (non-TEARDOWN) RTSP control messages from the client 110 are transparently forwarded by node 200 to the server 140 and the RTSP OK responses from the server 140 are transparently forwarded by node 200 to the client 110 (steps 943A-943E).

Eventually, the client 110 decides to “tear down” the data stream, generates an RTSP TEARDOWN message and forwards it to the server 140 (step 944). The TEARDOWN message travels through the network 100 to reservation control node 200. Reservation control node 200 receives the TEARDOWN message, forwards the TEARDOWN to the server 140 (step 946). The server 140 receives the TEARDOWN message, processes it in a conventional manner, generates a TEARDOWN OK message and forwards the TEARDOWN OK message to the client 110 (step 948). Reservation control node 200 receives the TEARDOWN OK message and holds on to it until the reservation associated with the session is torn down (step 950).

Node 200 generates an RSVP PathTear message to tear down the reservation, encapsulates the PathTear message in a tunnel packet and forwards the tunnel packet to the server's first hop node 300b via the tunnel (step 952). The server's first hop node 300b receives the tunnel packet, extracts the RSVP PathTear message contained therein and processes it in a conventional manner including forwarding it to the client 110 (step 954). The PathTear message travels hop-by-hop through the network 100 to the client's RSVP proxy node 300a which receives the message, processes it in a conventional manner, generates an RSVP ResvTear message and forwards it to the server 140 (step 956).

The ResvTear message travels hop-by-hop through the network to the server's first hop node 300b which receives the ResvTear message, processes it in a conventional manner, encapsulates it in a tunnel packet and forwards the tunnel packet to the reservation control node 200 via the tunnel (step 958). Reservation control node 200 receives the ResvTear message and processes it including concluding that the reservation of resources between the server's RSVP proxy node 300b and the client's RSVP proxy node 300a has been successfully torn down (step 960). Reservation control node then forwards the next re-transmitted TEARDOWN OK message to the client 110 (step 962). The client 110 receives the TEARDOWN OK message and concludes that the data stream has been successfully torn down (step 964).

An embodiment of the IGMP call admission and control technique described herein is based on a variant of IGMP that is supported in Cisco IOS. RFC 3077 describes Unidirectional Link Routing (UDLR) which is used to make multicast routing operate over unidirectional satellite links. Cisco IOS supports a version of IGMP to work over unidirectional links (IGMP UDLR). IGMP UDLR may be used to create IGMP packets that have unicast destination IP addresses instead of the multicast destination IP addresses that are specified in RFCs 2236 and 3376. The unicast destination IP address is used to route the IGMP packet past the last hop router to the RSVP proxy.

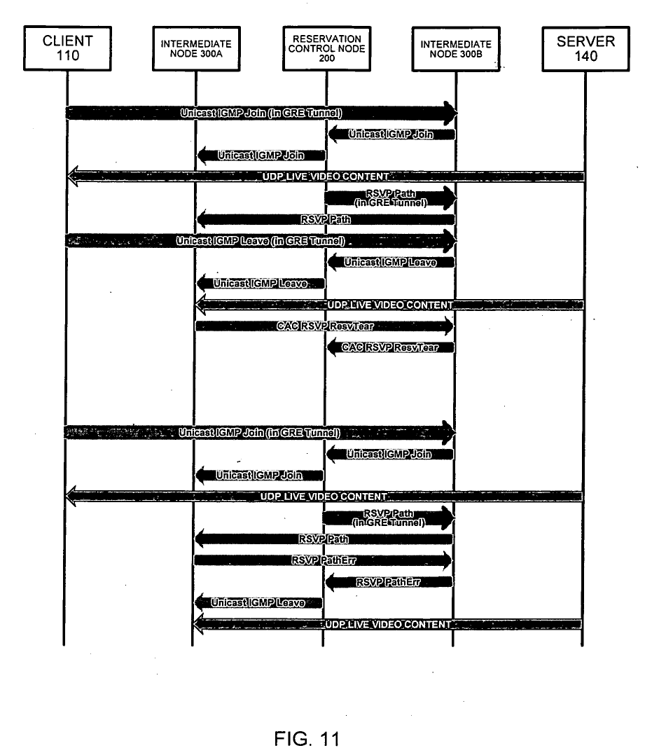

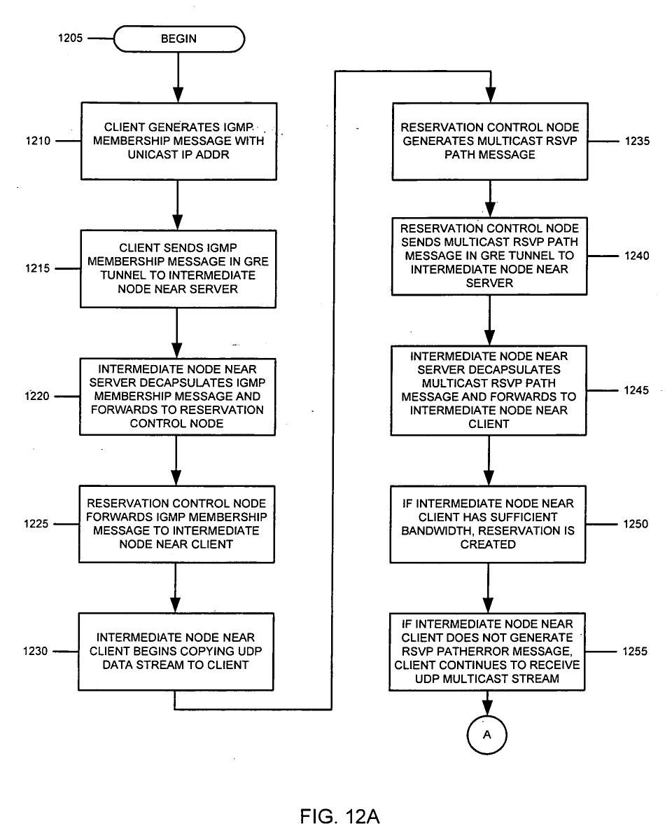

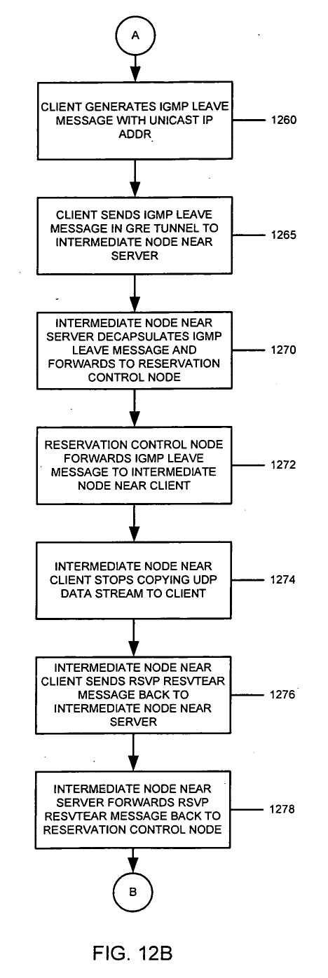

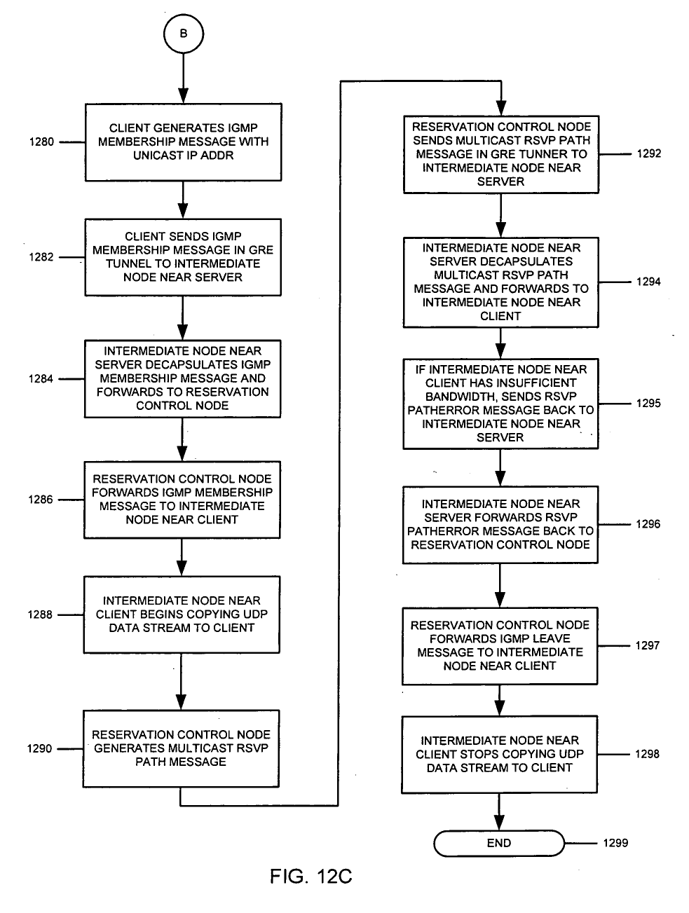

FIG. 11 illustrates a dialog between a client and a server with respect to a data streaming session for streaming data between the client and server using IGMP. FIGS. 12A-C illustrate a flow chart of a sequence of steps that may be used to stream data between a client and a server using IGMP. With reference to FIG. 12A, the sequence begins at step 1205 and proceeds to step 1210 where the client 110 generates an IGMP “membership” message with a unicast IP address. At step 1215, the client sends the IGMP membership message in a GRE tunnel to the intermediate node 300b near the server. The intermediate node near the server decapsulates the IGMP membership message and forwards it to the reservation control node 200 at step 1220. At step 1225, the reservation control node forwards the IGMP membership message to the intermediate node 300a near the client which begins copying a UDP data stream to the client at step 1230.

The reservation control node generates a multicast RSVP PATH message at step 1235 and sends the RSVP PATH message in a GRE tunnel to the intermediate node 300b at step 1240. The intermediate node 300b decapsulates the multicast RSVP PATH message and forwards it to the intermediate node 300a at step 1245. If intermediate node 300a has sufficient bandwidth, a reservation is created at step 1250. If the intermediate node 300a does not generate an RSVP PATHERROR message, the client continues to receive the UDP multicast stream at 1255.

With reference to FIG. 12B, the sequence continues at step 1260 where the client generates an IGMP “leave” message with unicast IP address and sends it in a GRE tunnel to the intermediate node 300b at step 1265. At step 1270, the intermediate node 300b decapsulates the IGMP leave message and forwards it to the reservation control node which forwards the IGMP leave message to the intermediate node 300a at step 1272. The intermediate node 300a stops copying the UDP data stream to the client at step 1274. At step 1276, the intermediate node 300a sends an RSVP RESVTEAR message back to the intermediate node 300b which forwards the RSVP RESVTEAR message back to the reservation control node at step 1278.

Referring now to FIG. 12C, the sequence of steps 1280 to 1294 are identical to steps 1210 to 1245 in FIG. 12A. At step 1295, however, if intermediate node 300a does not have sufficient bandwidth, it sends an RSVP PATHERROR message back to the intermediate node 300b. At step 1296, the intermediate node 300b forwards the RSVP PATHERROR message back to the reservation control node which then forwards an IGMP leave message to intermediate node 300a at step 1297. At step 1298, the intermediate node 300a stops copying the UDP data stream to the client and the sequence ends at step 1299.

While this invention has been particularly shown and described with references to preferred embodiments thereof, it will be understood by those skilled in the art that various changes in form and details may be made therein without departing from the scope of the invention encompassed by the appended claims.

1. A method for reserving resources for data streams in a communication network, the method comprising:
monitoring one or more messages transferred between a first entity in the communication network and a second entity in the communication network;
determining from the monitored messages that a session to stream a data asset from the first entity to the second entity is being established; and
reserving resources in the communication network that are to be used to accommodate streaming the data asset from the first entity to the second entity.

2. A method as defined in claim 1 wherein reserving resources comprises generating a message to reserve the resources; and forwarding the message to reserve the resources.

3. A method as defined in claim 2 further comprising encapsulating the message to reserve the resources in a tunnel packet; and forwarding the tunnel packet via a tunnel.

4. A method as defined in claim 1 wherein determining includes obtaining information associated with the data asset; and reserving resources includes using the obtained information to reserve the resources.

5. A method as defined in claim 4 wherein reserving resources further includes generating a message to reserve the resources from obtained information associated with the data asset; and forwarding the message to reserve the resources.

6. A method as defined in claim 4 wherein reserving resources further includes generating a request for information associated with the data asset; and forwarding the request to the first entity.

7. A method as defined in claim 6 further comprising receiving a reply message containing information associated with the data asset from the first entity; and using the received information associated with the data asset to generate a message to reserve the resources.

8. A method as defined in claim 7 wherein the received information includes bandwidth information associated with the data asset.

9. A method as defined in claim 7 further comprising forwarding the message to reserve the resources.

10. A method as defined in claim 2 further comprising receiving a confirmation message indicating that the resources have been reserved.

11. A method as defined in claim 10 wherein the confirmation message is encapsulated in a tunnel packet.

12. A method as defined in claim 1 further comprising determining from the monitored messages that the session is to be torn down; and causing the resources to no longer be reserved.

13. A method as defined in claim 12 further comprising generating a message to tear down the reservation; and forwarding the message to tear down the reservation.

14. A method as defined in claim 13 further comprising encapsulating the message to tear down the reservation in a tunnel packet; and forwarding the tunnel packet via a tunnel.

15. A method a defined in claim 13 further comprising receiving a message confirming the reservation has been torn down; and concluding the reservation is torn down.

16. A method as defined in claim 15 wherein the confirmation message is encapsulated in a tunnel packet.

17. An entity in a communication network, the entity comprising a network interface configured to receive one or more messages transferred between a first entity in the communication network and a second entity in the communication network; and processing circuitry configured to determine from the received messages that a session to stream a data asset from the first entity to the second entity is being established, and reserve resources in the communication network that are to be used to accommodate streaming the data asset from the first entity to the second entity.

18. An entity as defined in claim 17 wherein the processing circuitry is further configured to generate a message to reserve the resources, and forward the message to reserve the resources.

19. An entity as defined in claim 18 wherein the processing circuitry is further configured to encapsulate the message to reserve the resources in a tunnel packet, and forward the tunnel packet via a tunnel.

20. An entity as defined in claim 17 wherein the processing circuitry is further configured to obtain information associated with the data asset, and use the obtained information to reserve the resources.

21. An entity as defined in claim 20 wherein the processing circuitry is further configured to generate a message to reserve the resources from obtained information associated with the data asset, and forward the message to reserve the resources.

22. An entity as defined in claim 20 wherein the processing circuitry is further configured to generate a request for information associated with the data asset, and forward the request to the first entity.

23. An entity as defined in claim 22 wherein the network interface is further configured to receive a reply message containing information associated with the data asset from the first entity, and the processing circuitry is further configured to use the received information associated with the data asset to generate a message to reserve the resources.

24. An entity as defined in claim 23 wherein the received information includes bandwidth information associated with the data asset.

25. An entity as defined in claim 23 wherein the processing circuitry is further configured to forward the message to reserve the resources to the first entity.

26. An entity as defined in claim 18 wherein the processing circuitry is further configured to receive a confirmation message indicating that the resources have been reserved.

27. An entity as defined in claim 26 wherein the confirmation message is encapsulated in a tunnel packet.

28. An entity as defined in claim 17 wherein the processing circuitry is further configured to determine from the received messages that the session is to be torn down, and cause the resources to no longer be reserved.

29. An entity as defined in claim 28 wherein the processing circuitry is further configured to generate a message to tear down the reservation, and forward the message to tear down the reservation.

30. An entity as defined in claim 29 wherein the processing circuitry is further configured to encapsulate the message to tear down the reservation in a tunnel packet, and forward the tunnel packet via a tunnel.

31. An apparatus for reserving resources for data streams in a communication network, the apparatus comprising:
means for monitoring one or more messages transferred between a first entity in the communication network and a second entity in the communication network;
means for determining from the monitored messages that a session to stream a data asset from the first entity to the second entity is being established; and
means for reserving resources in the communication network that are to be used to accommodate streaming the data asset from the first entity to the second entity.

32. An apparatus as defined in claim 31 wherein means for reserving resources includes means for generating a message to reserve the resources and means for forwarding the message to reserve the resources.

33. A method for reserving resources for data streams in a communication network, the method comprising:
reserving resources in the communication network that are to be used to accommodate streaming of a data asset from a first entity to a second entity using RSVP messaging.

34. A method as defined in claim 33 wherein reserving resources comprises generating an RSVP Path message to reserve the resources; and forwarding the RSVP Path message to reserve the resources.

35. A method as defined in claim 34 further comprising encapsulating the RSVP Path message to reserve the resources in a tunnel packet; and forwarding the tunnel packet via a tunnel.

36. A method as defined in claim 33 wherein reserving resources further includes generating an RSVP Path message to reserve the resources from information associated with the data asset; and forwarding the RSVP Path message to reserve the resources.

37. A method as defined in claim 33 wherein reserving resources further includes generating a request for information associated with the data asset; and forwarding the request to the first entity.

38. A method as defined in claim 37 further comprising receiving a reply message containing information associated with the data asset from the first entity; and using the received information associated with the data asset to generate an RSVP Path message to reserve the resources; and forwarding the RSVP Path message to reserve the resources.

39. A method as defined 38 wherein the received information includes bandwidth information associated with the data asset.

40. A method as defined in claim 33 further comprising receiving an RSVP Resv message indicating that the resources have been reserved.

41. A method as defined in claim 40 wherein the RSVP Resv message is encapsulated in a tunnel packet.

42. A method as defined in claim 33 further comprising generating an RSVP PathTear message to tear down the reservation; and forwarding the RSVP PathTear message to tear down the reservation.

43. A method as defined in claim 42 further comprising encapsulating the RSVP PathTear message to tear down the reservation in a tunnel packet; and forwarding the tunnel packet via a tunnel.

44. A method as defined in claim 42 further comprising receiving an RSVP ResvTear message confirming the reservation has been torn down; and concluding the reservation is torn down.

45. A method as defined in claim 44 wherein the RSVP ResvTear message is encapsulated in a tunnel packet.

46. A method as defined in claim 33 wherein reserving resources comprises:
generating an RSVP Path message to reserve the resources;
encapsulating the RSVP Path message in a tunnel packet;
forwarding the tunnel packet via a tunnel; and
receiving an RSVP Resv message indicating that the resources have been reserved.

47. A method as defined in claim 46 wherein the RSVP Resv message is encapsulated in a tunnel packet.

48. An entity in a communication network, the entity comprising a network interface configured to receive one or more messages transferred between a first entity in the communication network and a second entity in the communication network; and processing circuitry configured to reserve resources in the communication network that are to be used to accommodate streaming of a data asset from the first entity to the second entity using RSVP messaging.

49. An entity as defined in claim 48 wherein the processing circuitry is further configured to generate an RSVP Path message to reserve the resources and forward the RSVP Path message to reserve the resources.

50. An entity as defined in claim 49 wherein the processing circuitry is further configured to encapsulate the RSVP Path message to reserve the resources in a tunnel packet and forward the tunnel packet via a tunnel.

51. An entity as defined in claim 48 wherein the processing circuitry is further configured to generate an RSVP Path message to reserve the resources from information associated with the data asset and forward the RSVP Path message to reserve the resources.

52. An entity as defined in claim 48 wherein the processing circuitry is further configured to generate a request for information associated with the data asset and forward the request to the first entity.

53. An entity as defined in claim 52 wherein the network interface is further configured to receive a reply message containing information associated with the data asset from the first entity, and wherein the processing circuitry is further configured to use the received information associated with the data asset to generate an RSVP Path message to reserve the resources and forward the RSVP Path message to reserve the resources.

54. An entity as defined in claim 53 wherein the received information includes bandwidth information associated with the data asset.

55. An entity as defined in claim 48 wherein the processing circuitry is further configured to receive an RSVP Resv message indicating that the resources have been reserved.

56. An entity as defined in claim 55 wherein the RSVP Resv message is encapsulated in a tunnel packet.

57. An entity as defined in claim 48 wherein the processing circuitry is further configured to generate an RSVP PathTear message to tear down the reservation and forward the RSVP PathTear message to tear down the reservation.

58. An entity as defined in claim 57 wherein the processing circuitry is further configured to encapsulate the RSVP PathTear message to tear down the reservation in a tunnel packet and forwarding the tunnel packet via a tunnel.

59. An entity as defined in claim 57 further comprising receiving an RSVP ResvTear message confirming the reservation has been torn down; and concluding the reservation is torn down.

60. An entity as defined in claim 59 wherein the RSVP ResvTear message is encapsulated in a tunnel packet.

61. An entity as defined in claim 48 wherein the processing circuitry is configured to reserve resources by generating an RSVP Path message to reserve the resources; encapsulating the RSVP Path message in a tunnel packet; forwarding the tunnel packet via a tunnel; and receiving an RSVP Resv message indicating that the resources have been reserved.

62. An entity as defined in claim 61 wherein the RSVP Resv message is encapsulated in a tunnel packet.
